(19) United States
(12) Patent Application Publication
(10) Pub. No.: US 2018/0012438 A1
(43) Pub. Date: Jan. 11, 2018

(54) Charging Stations For Portable Electronic Devices

(71) Applicant: Robert Sinofsky, Ft. Lauderdale, FL (US)

(72) Inventor: Robert Sinofsky, Ft. Lauderdale, FL (US)

(21) Appl. No.: 15/636,594

(22) Filed: Jun. 28, 2017

Related U.S. Application Data
(60) Provisional application No. 62/355,631, filed on Jun. 28, 2016.

(51) Int. Cl. G07F 15/00; G06Q 20/14; G06Q 20/20; G06Q 20/18; H02J 7/00; G07F 17/16

(52) U.S. Cl. CPC G07F 15/005; G06Q 20/18; H02J 7/0052; H02J 7/0044; G06Q 20/145; G06Q 20/202; H02J 2007/0062; G07F 17/16

(57) ABSTRACT

A pay-per-use battery charging system for charging portable electronic devices, such as cellular telephones, tablet computers, etc. The charging system may be implemented as a central hub that dispense charging devices, as a standalone device, or may be incorporated into commonly available devices, such as customer order entry stations, ATMs, vending machines, etc., which now also provide the function of charging stations for the convenience of users. The system provides power to portable electronic devices via common USB cables, such that no additional equipment is required by the individual to charge their portable electronic device. The system provides for payment by the user prior to charging their portable electronic device.

### CROSS-REFERENCE TO RELATED APPLICATIONS

This application is related to, and claims the benefit of, the provisional patent application entitled “Charging Stations for Portable Electronic Devices”, filed Jun. 28, 2017, bearing U.S. Ser. No. 65/355,631 and naming Robert Sinofsky, the named inventor herein, as sole inventor, the contents of which is specifically incorporated by reference herein in its entirety.

### BACKGROUND OF THE INVENTION

### Technical Field

The invention is related to charging stations for portable electronic devices. In particular, it relates to portable charging device dispensed from a central hub, to standalone charging stations, or incorporation of charging stations into pre-existing electronic devices.

### Background

Today, portable electronic devices, especially cellular telephones, are ubiquitous. They provide individuals and businessmen of all types with the convenience of Instant availability of communications for themselves, and for others who seek to communicate with them.

Originally, cellular telephones were fairly basic devices that provided a single function: mobile voice communications. However, as time went on, the capability and processing power of such devices rapidly increased such that today, many “smart phones” now have so many functions that they are more like a portable computer rather than a mere cellular phone. As a result, the amount of use that they get has substantially increased. That increase in use, while providing much greater functionality to the user, has also placed much more stress on the internal batteries of these devices, such that the batteries are drained faster than desired.

Battery usage is even more pronounced for portable devices such as tablet computers, notebook computers, laptop computers, portable gaming devices, etc. This is in large part due to the stress placed on batteries due to the larger display screen sizes of these devices in relation to a cellular phone.

If any of these portable devices are used in an office or home, then there is usually a convenient place to attach a power plug to recharge the battery when it is low. However, often these devices are used outside of the home or office where they may power down at an inconvenient time. For example, many individuals are busy making phone calls while traveling, at meetings, or at lunch. Businessmen may need to make phone calls at times like these, and having their portable devices power down can be exceedingly inconvenient. For these reasons, it would be advantageous to have ubiquitous charging stations available to individuals on a wide range of devices, such that loss of functionality due to battery exhaustion is avoidable.

While the prior art has provided some limited solutions, it has failed to provide a system that allows individuals to charge their devices in almost any location, especially in locations such as restaurants or other locations where are they may not be able to leave quickly when they lose battery power in their devices. The prior art has also failed to make the charging device portable, so that users can come and go as they please, without having to wait for their device to complete the charging process.

### SUMMARY OF THE INVENTION

The present invention provides a ubiquitous battery charging system that provides users the ability to power and charge portable electronic devices such as cellular telephones, etc. In a preferred embodiment, the system uses a central hub that dispenses portable charging devices that a user can carry with them while charging their portable device. The charging system can also be incorporated into commonly available devices, such as customer order entry stations, ATMs, vending machines, etc., which now also provide the function of charging stations for the convenience of users. The system provides power to portable electronic devices via common USB cables. As a result, no additional equipment is required by the user. The system provides for payment by the user prior to charging their portable electronic device, via cash or electronic payment systems.

### BRIEF DESCRIPTION OF THE DRAWINGS

FIG. 1 is a block diagram that illustrates the elements of the pay-per-use charging system.

FIG. 2 illustrates a pay-per-use charging system that is housed in a kiosk.

FIG. 3 illustrates a pay-per-use charging system that is housed in a kiosk that is designed for outdoor use.

### DESCRIPTION OF THE PREFERRED EMBODIMENT

Prior to a detailed discussion of the figures, a general overview of the invention will be presented. Many individuals have to stay connected in the sense that they need to be able to communicate while away from home or office. Many business professionals need to be in communication with their clients, or with online systems related to their work. Quite often, the portable electronic device used by an individual, such as a cellular telephone or a tablet will turn off when its battery is depleted. This can cause an annoying disruption in the individual's work. The invention provides a solution for many individuals, such as parents, salesmen, realtors or any other occupation that requires them to be available even though they are outside of a fixed location.

The invention is a distributed pay-per-use power charging system that is a portable device, or is incorporated into a variety of commonly prior art devices used by the public. While the primary embodiment uses portable charging devices that are dispensed by a central hub, alternative embodiments allow the charging devices to be incorporated into fixed locations or into pre-existing devices. For example, many restaurants today use table mounted customer order entry terminals that also function as point of sales terminals. Typically, when an individual is in a restaurant, they may be there for an extended period. In the event that the individual needs their phone for business reasons or otherwise, they may find that the battery has run dead and they are unable to make or receive an important call. The invention solves this problem by providing a conveniently power source that will allow an individual to recharge the battery in a device such as a cellular telephone, a tablet computer etc. In a preferred embodiment, the invention takes advantage of the fact that the vast majority of portable electronic devices now contain USB inputs. The invention provides a USB cable that the individual plugs into their portable electronic device so that it charges while the individual is dining at the restaurant table. This eliminates the problem of losing connectivity. An alternative embodiment also provides non-USB cables for devices that do not have a USB port.

The restaurant example given above is useful in that individuals may spend enough time while dining to completely charge the battery in their cell phone. Since the preferred embodiment is a portable charging station, users can take the charging device with them if their device is not fully charged when they are finished dining, and return the device to a convenient drop-off location when their device is fully charged. However, the invention can be effectively used in a variety of other locations in addition to restaurants. For example, casinos, hotels, airports/airplanes, shopping malls, cruise ships, sporting events, city streets, colleges and universities, etc., are illustrative of other locations that can easily make effective use of the invention, especially when the charging device is portable. In the case of a casino, an individual may spend substantial amounts of time in one location, such as a gaming table. All the individual would need is a USB port to charge their cell phone or other portable device. In the case of a hotel, USB ports would allow an individual to charge their phone in the lobby, in their room, or at the hotel's restaurant. Likewise, individuals that are traveling may spend several hours at an airport waiting for their plane. The invention allows them to keep their cell phones fully charged so that they will be ready when needed. In fact, any venue where an individual spends a substantial amount of time, such as shopping malls, sporting events, etc., can benefit from the invention.

An advantage provided by the invention is that when individuals are traveling or away from their home or office, they typically will not be carrying a charger for the phone. The invention obviates this problem because it only requires a USB cable that would be part of the charging station or dispensed with the charging device.

In addition to solving connectivity problems, the invention also enhances revenue for businesses that provide this service. As noted above, the invention is a pay-per-use power charging system. For devices such as customer order entry systems, they already have the means to accept payment, such as credit card readers. In addition, customer order entry systems can also be designed to accept cash in the same manner as a vending machine. And the preferred embodiment, the individual would have the option of activating the charger for a set period of time, or activating indefinitely until the individual turned it off. If using a credit or debit card, the card would be automatically billed for usage. For devices such as customer order entry terminals, ATMs, gas station pumps, etc., they already have Internet connections to charge for services. The invention takes advantage of these connections. In cases where no such connection is available in the device, the Internet access is provided by the power charging system. For example, a wireless modem, or other suitable means, can be integrated with the machine to enable internet communications.

The invention also provides a substantial benefit for travelers. It is a fairly common occurrence for travelers to pack their particular electronic device, such as a cell phone, tablet computer, etc., but forget to pack the charger for that device. While this is inconvenient in any situation, it can be particularly troublesome for travelers who are not able to retrieve the charger. For example, in the case of a cruise ship, an Individual may have only a few hours to use the device until the batteries drain. In situations such as this, where an individual is cut off from equipment they may need, conveniently located charging stations can be a godsend. The invention allows a traveler to charge their portable devices regardless of their current location. As a further convenience, the traveler's use fees could even be added to the facilities invoice, such as a hotel bill or cruise ship bill.

In a preferred embodiment, the establishment owner may receive a portion of the pay-per-use fee with the remaining amount going to the system provider. A further advantage for the establishment owner is that there is no extra cost for equipment or requirement for space. When the invention as implemented as a portable system, the pay-per-use terminal would not cost the establishment owner anything since the central hub that dispenses the charging devices would be installed by the owner of the pay-per-use charging system and would remain its property and responsibility. The establishment owner may optionally wish to forego their share of compensation for the purpose of providing customers with a reduced-price convenience that acts as an incentive to patronize their establishment.

In addition to customer order entry terminals, the invention could also be implemented on a variety of machines in the same manner. In fact, any machine that is designed to accept payment, such as an ATM, a gas station pump, a vending machine, etc. can be modified to provide this additional service. For some devices, the elements necessary to execute the invention would be built in to these machines during manufacture. For existing machines, a separate pay-per-use terminal can be fabricated and secured to the device in question, or used as an entirely separate stand-alone device. While the foregoing devices are listed as examples, those skilled in the art will realize that there is no practical limit to the number and types of devices that can be combined with the invention.

In the embodiments discussed above, the charging station is envisioned as a fixed station in a location such as a restaurant, etc. An alternative preferred embodiment envisions kiosks or vending machines that can be located at public locations that may be indoors or outdoors. These vending machines can be implemented as kiosks that may be located indoors or outdoors, at malls, on city streets or parks, etc. These vending machines allow a user to rent a charger at one location and return it to that location or to a different location. A variation of this embodiment allows a central hub that dispenses multiple chargers in an establishment that allows a user to take a charger to a location within the establishment, such as the user's table, bar seat, etc., or to take the charger off of the premises.

In the case of a kiosk, the preferred embodiment envisions a system that accepts credit or debit cards to secure payment for use of the charging device, and also places a hold on the credit/debit card for a “security deposit” to cover the cost of the charging device if it is not returned. If the charging device is not returned, the credit/debit card would then be billed for the deposit amount. Of course, when the charging device is returned, the system would not complete the charge for the security deposit to the credit card company and would drop the hold on the account. Preferably, each device distributed via a kiosk would have a barcode, RFID, or other identification, so that the system would know that the device was returned. This is similar to the manner in which other rental products, such as movie videotapes are tracked. The device will also have a mailing address on the label, so that if a renter forgets to return the device, they can return it via mail. In the event a charger is mailed in after the deposit amount is billed to a credit card company, the deposit amount would be credited to the user's credit card.

An alternative preferred embodiment also includes an Internet connection so that a user can have access to the Internet via the charging station or the base station. Having access to the Internet also provides the user with a way to pay for usage via pre-existing online payment systems, for example, the Apple™ iTunes™ store, Google™ play, PayPal™, ApplePay™, etc.

Another alternative preferred embodiment of the invention envisions a central hub (i.e., a base station) that is freestanding, or secured to a fixed location, such as a wall or table. In this embodiment, individual charging devices will be dispensed by the base station, and allow the user to transport the charging device to a convenient location, such as their table, a bar seat, or even allow the user to walk around with it while having access to their telephone, tablet, or other device. This is different from current charging systems in that prior art charging systems require the customer to put the device in a locker or stack their phones on a stationary device. As a result, they cannot have their phones with them as it charges.

Yet another embodiment uses the invention in conjunction with publicly available transportation vehicles, such as taxicabs, buses, trains, ride sharing services (e.g., Uber™), etc. This allows an individual to charge or power their device while commuting or traveling from one location to another. This embodiment, in combination with all of the other embodiments discussed, provides a ubiquitous charging system that is available to individuals in almost any location. It allows the user to transport the charging device until the user's device is fully charged and then return it to the original location or to a new location. As a result, the individual is never out of touch due to loss of power.

In a preferred embodiment, the system is a turnkey solution that requires minimal cost to the facility owner. The machines would be owned and serviced by the charging station supplier. Any Internet connections would be made via wireless modem in the charging station, or via an Ethernet connection that uses the location's pre-existing Internet facility. As a result, the only cost for the facility would be for electricity, and a location to place the charging station/devices.

An important advantage of the invention is that the charging device is portable. Heretofore, charging stations were used in fixed locations. The portability of the system is a distinct advantage over prior art charging systems, because the invention allows a user to acquire a charging station that is dispensed from a central hub and can be used while moving from one location to another, and returned to a different location.

Another advantage of the invention is that it may be incorporated into pre-existing devices. For example, many restaurants now have order entry tablets that are located at each table. These devices already communicate with a central controller that manages orders and payment. The invention can take advantages of this pre-existing equipment by merely adding or USB port to provide a link for charging. There would be no need to add additional equipment for billing, since these devices are already designed to accept payment.

Preferably, the charging device will have an output port for a USB cable connector. However, those skilled in the art will recognize that some tablet devices such as an iPad™ do not have a standard USB input port. Instead, the iPad uses a different input connector. As a result, to accommodate user devices that have differing input ports, the central hub would have a selection of cables that allow the user to choose a charging device and also select an appropriate cable from one of several cable types to suit the user's particular device.

Having discussed the features and advantages of the invention in general, we turn now to a more detailed discussion of the figures.

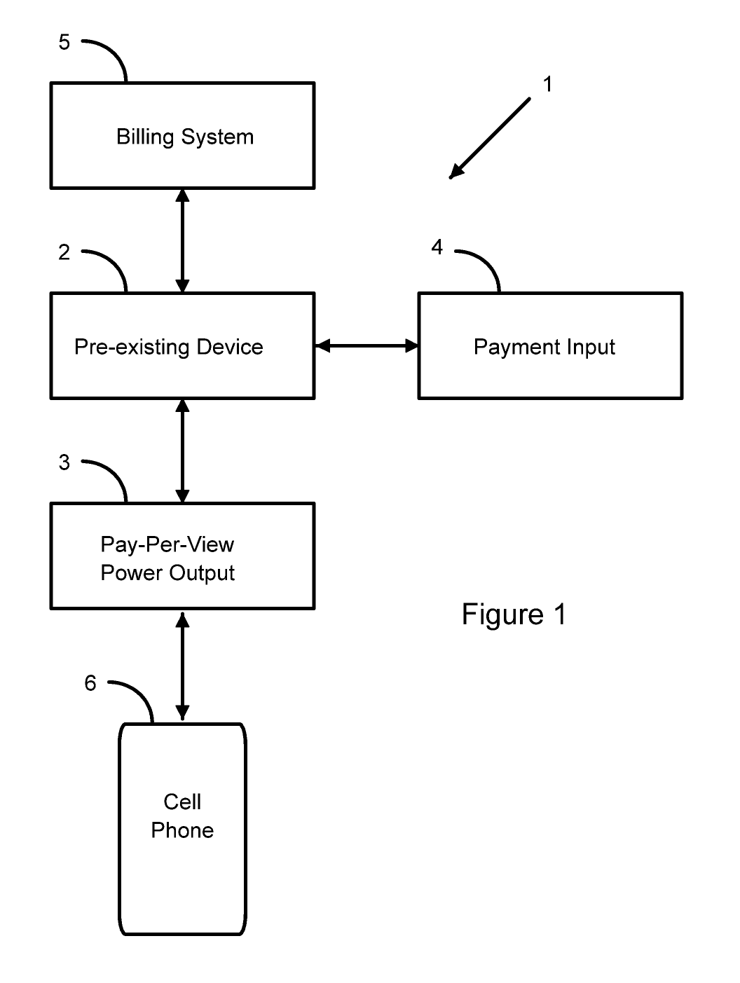

FIG. 1 is a block diagram that illustrates the elements of the pay-per-use charging system 1.

In the preferred embodiment, the pay-per-use charging system 1 is used in combination with a pre-existing device, such as the order entry device 2. The pre-existing device can be anything that is capable of accepting payment, such as an order entry device, an ATM, a gas station pump, etc. For ease of discussion, FIG. 1 uses an order entry device 2 found in many restaurants, although any number of device types can be used in its place. The charging system 1 adds a pay-per-use power output 3.

In this figure, the pay-per-use power output 3 is a USB cable that extends from the order entry device 2. A USB cable is preferred due to its widespread use throughout the electronics industry. As a result, most electronic devices can be charged through their USB port. In this figure, the USB cable is shown attached to a cellular telephone 6, but it could be any other type of device with a USB port. In an alternative preferred embodiment, when a user dispenses a portable charging device from the central hub, the hub also dispenses several power cords to support commonly used devices, typically two to four different charging cables. For example, an Apple iPad does not have a port for a standard USB cable. As a result, the central hub provides the user with a choice of charging cables to accommodate devices with different types of power input ports. In practice, the different power cords may be bundled into a single cable with different connectors, whereby the user would select which connection is appropriate for attachment to the user's device. Alternatively, a single cable with multiple plugs can be attached to the battery so that multiple users could attach their devices to the same battery.

Once payment is made and accepted through payment input 4, the charger is dispensed and ready for use. The user then plugs the power cord into the cellular phone 6 or other device. Payment can be made by credit or debit card, or even by cash. A restaurant order entry device will typically have a credit card reader to accept payment for the meal ordered at the restaurant. As a result, there would be no additional hardware needed to implement this function. That is also true for cash station pumps, ATMs, and even some vending machines. When the order entry device reads the payment information from the payment input device 4, it then submits that information to the billing system 5 for payment. The billing system 5 can be a local system, or a remote system accessed via the Internet. After payment is confirmed, the charging process begins.

When using a portable charging device, at a restaurant or elsewhere, the first step for the user is to input their payment information. Prior to dispensing the charging device, the central hub 1) charges the credit/debit card for the use of the charging device, and 2) places a hold on the credit/debit for the amount of the security deposit in case the charging device is not returned. If the billing system 5 authorizes the payment, it informs the order entry device 3 (for fixed location charging stations), and activates the pay-per-use power output 6. For portable charging devices dispensed from a central hub, the central hub contacts the financial institution to authorize payment for use and a hold for a security deposit. When the financial institution approves the transaction, the central hub dispenses the portable charging device.

In addition, the battery can also be fabricated as a water proof device because the user may expose it to adverse weather conditions.

As noted above, alternate embodiments of the system can accept cash in the form of bills or coins. If the invention is incorporated into a vending machine, the currency input in a conventional vending machine would already be there, so the cost to implement cash acceptance would be minimized.

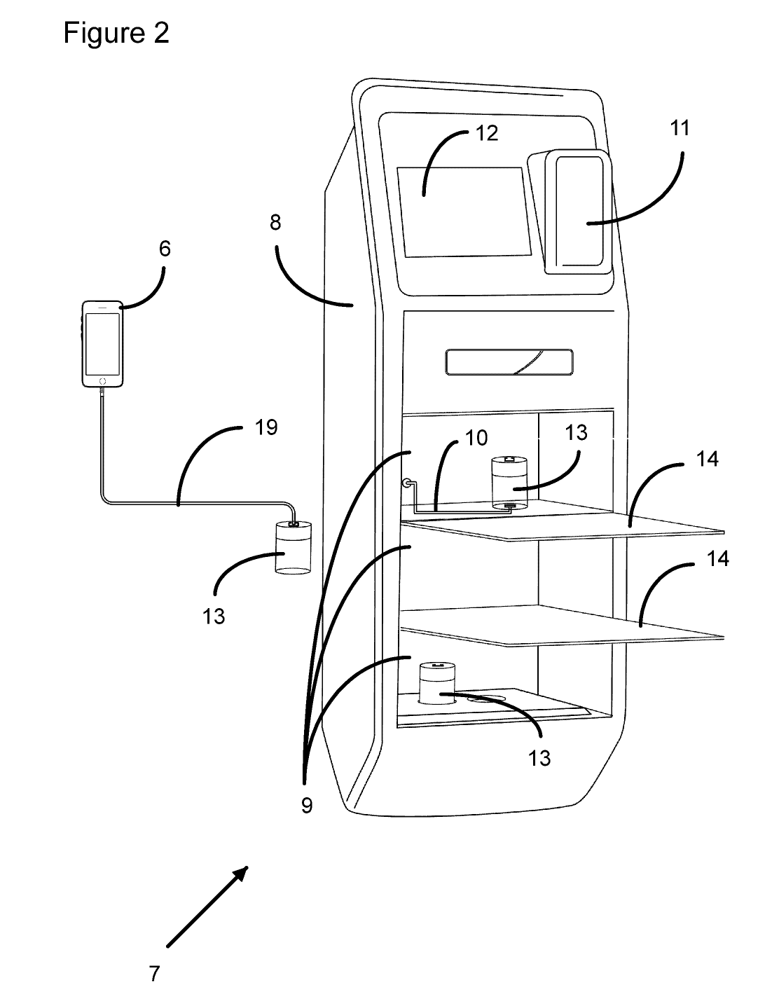

FIG. 2 illustrates a pay-per-use charging system 1 that is housed in a kiosk 7. In this figure, the kiosk 7 has an exterior covert 8 that houses a display panel 12, a data entry panel 11 and several charger storage units 9. Those skilled in the art will recognize that the functions of the display panel 12 and the data entry panel 11 can be combined into a single touch panel screen.

Each storage unit 9 is illustrated with door panels 14 in the open position for ease of discussion. Of course, during normal operation the door panels 14 would remain locked until the pay-per-use charging system 1 unlocked the door panel 14 after a customer transaction was authorized. Once the transaction is authorized, the selected door panel 14 will open and the customer can access the charging battery 13 inside.

And the preferred embodiment, the charging battery 13 has an RFID circuit, or suitable equivalent, that contains a unique identification code that identifies that particular charging battery 13. In the event that the cable 19 is permanently connected to the charging battery 13, then the identification circuit could be embedded in the cable 19. Use of a unique identification number allows the system to identify each particular charging battery 13 when it is taken out by a customer, and also to identify that charging battery 13 one that is returned, whether it be to that kiosk 7 or to any other location.

The bottom door panel 14 is intentionally omitted from the figure to provide a clear view of the charging battery 13 that is mounted in a receptacle inside the storage unit 9. As can be seen, the charging battery 13 in the lower storage panel 9 is inserted into a charging port, while the charge inventory 13 in the upper storage unit 9 is attached via charging cable 10. This figure illustrates that the charging batteries 13 can be charged via any suitable method. Once the transaction is complete, the customer removes the charging battery 13 and attaches it via cable 19 to cell phone 6.

For ease of illustration, a cellphone 6 is shown to illustrate a typical portable electronic device may need a power source to recharge its internal battery. And the preferred embodiment, the charging cable 19 can be a USB cable, or any other suitable cable depending on the nature of the device. For example, non-cellphone devices, such as a portable computer, an iPad™, a portable game machine, etc. They have entirely different plug structures. In the preferred embodiment, a variety of cables may be selected by a customer to suit that customer's needs. This can be accomplished by dispensing cables 19 separately, or by dispensing the cable 19 with the charging battery 13.

Once the customer has the charging battery 13 and the appropriate cable 19, the customer can take the charging battery 13 and the appropriate cable 19 to the location where it can be used, such as a restaurant table, a waiting room a hospital or airport, etc. This allows the customer to have continuous use of the customer's device while waiting, dining, etc. In addition to the convenience discussed above in regard to restaurants, this can be even more useful for individuals who spend substantial amounts of time in waiting rooms. For example, it is not uncommon for travelers were flying from one part of the country to another to spend hours in a waiting area prior to boarding an aircraft. Even if the battery in the individual's device does not run dead before takeoff, it will probably fail very early in the flight. This is especially difficult for business travelers who may wish to take advantage of the hours spent inflight to work using their electronic device. In addition, once the customer is leaving, the battery can be returned to the kiosk 7, where it can be recharged for the next customer.

When a customer initiates a transaction, the customer provides identify information, such as the customer's credit card number to the pay-per-use charging system 1. The pay-per-use charging system 1 accesses the appropriate financial system via a communications link (not shown). The communications link may be any suitable and known communications technology, such as an Internet connection.

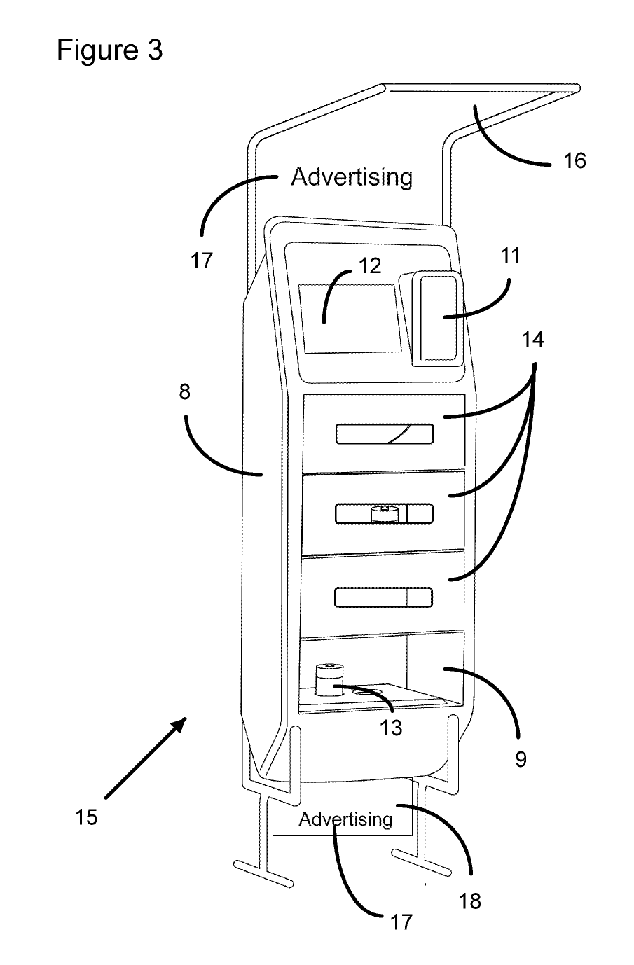

FIG. 3 illustrates a pay-per-use charging system 1 that is housed in a kiosk 15 that is designed for outdoor use. This embodiment is similar to that of the previous embodiment with the exception that a protective cover 16 has been added to provide some protection for the kiosk 15 from the weather.

Also illustrated in this figure as the use of a protective cover 16 as a platform for advertising material 17. This provides the kiosk owner with some additional advertising revenue. Further, a secondary advertising panel 18 can also be headed to the kiosk 15. When using the kiosk 15 as an advertising platform, the advertisements can be presented as conventional still signs or rotating digital advertising. In the case of digital advertising, the kiosk 15 can present moving color images, and can even be combined with audio messages. Those skilled in the art will recognize that any of the embodiments can implement the advertising feature.

While the invention has been described with respect to a preferred embodiment thereof, it will be understood by those skilled in the art that various changes in detail may be made therein without departing from the spirit, scope, and teaching of the invention. For example, the type of device that the invention is incorporated into can vary, the type of power cable or cables can vary to suit particular devices that need to be charged, etc. Accordingly, the invention herein disclosed is to be limited only as specified in the following claims.

I claim:

1. (canceled)

2. A charging station for portable electronic devices, comprising:
a battery charging station, operatively controlled by a pre-existing device, the pre-existing device further comprising:
a payment input for inputting payment instructions;
a communication link between the battery charging station and a remote financial institution, whereby the remote financial institution receives the payment instructions and responds with a payment authorization or a payment rejection of the payment instructions;
a power output that activates when the battery charging station receives a payment authorization from the remote financial institution; and
at least one charging cable, operatively attached at a first end to the power output, and having an electrical connector on a second end for attachment to the power input of a portable electronic device;
whereby the pre-existing device inputs payment instructions to a remote financial institution and outputs power to a portable electronic device when authorized by the remote financial institution.

3. A charging station, as in claim 2, wherein the payment instructions include data identifying specific credit or debit accounts, and further including the amount the remote financial institution is authorized to approve.

4. A charging station, as in claim 2, further comprising:
battery storage compartment, storing at least one battery, the battery storage area compartment secured in a locked configuration, and changed to an unlocked configuration when a payment authorization is received.

5. A charging station, as in claim 4, wherein the battery storage area is a component of a self-contained kiosk.

6. A charging station, as in claim 2, wherein the charging station is a component of a pre-existing device.

7. A charging station, as in claim 6, wherein the pre-existing device further comprises:
a power output for connection to the power input of a portable electronic device; and
a power cable for connection of the power output of the charging station to the power input of the portable electronic device.

8. A charging station, as in claim 6, wherein the pre-existing device is an order entry device.

9. A charging station, as in claim 8, wherein the pre-existing device further comprises:
a power output for connection to the power input of a portable electronic device; and
a power cable for connection of the power output of the charging station to the power input of the portable electronic device.

10. A charging station, as in claim 6, wherein the payment input on the pre-existing device is a touch panel screen and/or a charge card reader.

11. A charging station, as in claim 10, wherein the payment input on the pre-existing device is a portable electronic device.

12. A charging station, as in claim 11, wherein the portable electronic device is a smart phone.

13. A charging station, as in claim 2, wherein the charging station is a self-contained kiosk.

14. A charging station, as in claim 13, wherein the self-contained kiosk is an order entry station.

15. A charging station, as in claim 13, wherein the self-contained kiosk further comprises at least one advertising panel.

16. A method of providing on-demand battery charging for portable electronic devices, including the steps of:
a payment input for inputting payment instructions into a pre-existing device;
communicating the payment instructions to a remote financial institution for approval or rejection;
activating a power output in the pre-existing device when the remote financial institution approves the payment instructions and responds with a payment authorization;
using a power cable to connect the power output in the pre-existing device to the power input of a portable electronic device; and
activating the power output on the pre-existing device when the battery charging station receives a payment authorization from the remote financial institution;
whereby the pre-existing device inputs payment instructions to a remote financial institution and outputs power to a portable electronic device when authorized by the remote financial institution.

17. A method, as in claim 16, including the additional steps of:
including specific credit or debit accounts, and;
including the amount the remote financial institution is authorized to approve in the payment instructions.

18. A method, as in claim 17, including the additional steps of using an order entry device as the pre-existing device.

19. A method, as in claim 18, including the additional step of:
outputting power to the power input of a portable electronic device.

20. A method, as in claim 17, including the additional step of using a touch panel screen and/or a charge card reader on the pre-existing device to input payment instructions.

21. A method, as in claim 20, including the additional step of using smart phone as the portable electronic device.
